(19) United States
(12) Patent Application Publication
(10) Pub. No.: US 2021/0242531 A1
(43) Pub. Date: Aug. 5, 2021

(54) Vehicle with a High-Voltage Accumulator

(71) Applicant: BAYERISCHE MOTOREN WERKE AKTIENGESELLSCHAFT, Muenchen (DE)

(72) Inventors: Jana BECK, Oberkirch (DE); Tobias SCHMIEG, Unterfoehring (DE)

(21) Appl. No.: 17/053,964

(22) PCT Filed: Jun. 13, 2019
(86) PCT No.: PCT/EP2019/065442

§ 371 Date: Nov. 9, 2020

(30) Foreign Application Priority Data
Jul. 9, 2018 (DE) 10 2018 211 316.5

(51) Int. Cl. H01M 50/383; H01M 50/143; A62C 2/06; A62C 3/07; H01M 50/502; H01M 10/34; H01M 50/578

(52) U.S. Cl. CPC H01M 50/383; H01M 50/143; A62C 2/065; H01M 2220/20; H01M 50/502; H01M 10/34; H01M 50/578; A62C 3/07

(57) ABSTRACT

A vehicle has a high-voltage accumulator which has a high-voltage accumulator housing. At least one accumulator cell is arranged in the high-voltage accumulator housing and has an emergency degassing opening that is closed in a gas-tight manner in a normal state of the accumulator cell and opens when a specified internal pressure in the interior of the accumulator cell is exceeded so that a hot or burning gas can leak out of the accumulator cell into the high-voltage accumulator housing. Granulate which expands when heated by incident hot or burning gas is provided in sub-regions of the high-voltage accumulator. The sub-regions are arranged in the region of the emergency degassing opening of the at least one accumulator cell.

### BACKGROUND AND SUMMARY OF THE INVENTION

The present invention relates to a vehicle having a high-voltage accumulator.

Hybrid or electric vehicles comprise a high-voltage accumulator, in which electrical energy for driving a vehicle tractive power-generating electrical machine is stored. A high-voltage accumulator of this type comprises a high-voltage accumulator housing, in which at least one, and customarily a plurality of electrical storage cells are arranged. A plurality of such storage cells are customarily electrically interconnected to constitute a “cell module”.

In extreme cases, e.g. in the event of severe accidents, the high-voltage accumulator or individual storage cells can sustain damage. In turn, in an extreme case, this can result in the internal short-circuiting of cells, and a consequent increase in pressure and temperature in the interior of damaged storage cells.

Accordingly, the housings of storage cells customarily incorporate an “emergency degassing opening”. Under normal conditions, i.e. where the storage cells assume a correct state, the emergency degassing openings of the storage cells are closed in a gas-tight manner. In the event of an overshoot of a predefined internal storage cell pressure, the relevant emergency degassing opening opens or fails, such that hot or, in an extreme case, burning gas can escape from the interior of the storage cell into the interior space of the high-voltage accumulator housing. Occupants of the vehicle are thus protected by the high-voltage accumulator housing and by the passenger compartment.

The object of the invention is the provision of a vehicle having a high-voltage accumulator, which incorporates further improved fire protection.

The starting point of the invention is a vehicle having a high-voltage accumulator, which comprises a high-voltage accumulator housing. At least one storage cell is arranged in the high-voltage accumulator housing. Preferably, a plurality or a multiplicity of storage cells are arranged in the high-voltage accumulator housing, wherein a plurality of storage cells can be electrically interconnected to constitute “cell modules”.

The at least one storage cell incorporates an emergency degassing opening which, in a normal state of the storage cell, i.e. where the storage cell is in a correct state, is closed in a gas-tight manner, and which opens in the event of an overshoot of a predefined internal pressure in the interior of the storage cell. In an extreme case, i.e. in the event of a rise in pressure and temperature in the interior of the storage cell, e.g. as a result of an internal short-circuit in the cell and/or mechanical damage sustained by the storage cell, hot or burning gas can escape from the interior of the storage cell via the then opening emergency degassing opening into the high-voltage accumulator housing.

The core element of the invention is the provision, at least in subregions of the high-voltage accumulator, which are arranged in the region of the emergency degassing opening of the at least one storage cell, of granulates which, in the event of heat-up associated with the application of hot or burning gas thereto, undergo expansion and thus deploy a fire-inhibiting and/or insulating action.

A further advantage to be considered in conjunction with granulates is the resulting reduction in the infeed of oxygen, particularly where the granulates melt, in the manner of glass. The granulate melting process consumes a large quantity of thermal energy and, in the molten state, the granulates constitute an oxygen-impermeable mass, i.e. the free volume of air, and thus the quantity of oxygen, is reduced. Granulates further have a high specific thermal capacity, i.e. they can absorb a large quantity of thermal energy.

Tests have shown that granulates of a volcanic rock, such as e.g. raw perlite, are particularly appropriate as granulates.

Preferably, granulates are employed which incorporate water entrapments. Upon the heat-up of granulates, the entrapped water is vaporized, thereby resulting in the swelling of granulates. An up to twenty-fold expansion in the volume of granulates can occur, as a result of which a significant fire-inhibiting and insulating action is achieved.

Granulates can be arranged, for example, on an inner wall of the high-voltage accumulator which faces the emergency degassing opening of the at least one storage cell. Alternatively or additionally, the granulates can also be arranged on a cell contact-connection system which is arranged above the emergency degassing opening of the at least one storage cell, by means of which the poles of a plurality of storage cells are electrically interconnected.

By means of the invention, the hazard potential originating from high-voltage accumulators in extreme cases can be significantly reduced still further. The measure according to the invention can be implemented cost-effectively, and is associated with only a comparatively small additional weight. As mentioned above, natural materials such as, e.g., volcanic perlite can be employed as granulates. Natural materials of this type are reusable, depositable, have no harmful health effects and exhibit strong fire-inhibiting and insulating properties.

The invention is described in greater detail hereinafter, with reference to the drawings.

### BRIEF DESCRIPTION OF THE DRAWINGS

FIGS. 1 and 2 show different exemplary embodiments, according to the invention, in a highly schematic representation.

### DETAILED DESCRIPTION OF THE DRAWINGS

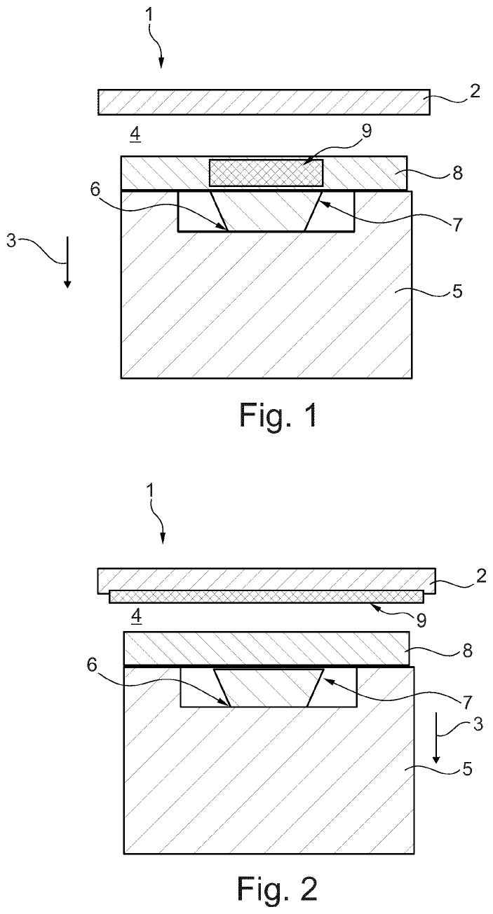

FIG. 1 shows a section of a high-voltage accumulator 1 comprising a high-voltage accumulator housing, of which only one wall 2 is represented here, which can be, for example, a cover, i.e. an “upper wall” of the high-voltage accumulator housing, in relation to the direction of gravitational force 3. In an interior space 4 of the high-voltage accumulator housing, a plurality or a multiplicity of storage cells are arranged, of which, in the exemplary representations according to FIGS. 1 and 2, only one storage cell 5 is represented. On an upper side of the storage cell 5, an emergency degassing opening 6 is provided. Under normal conditions, i.e. where the storage cell 5 is in a correct state, the emergency degassing opening is closed in a gas-tight manner. This means that, in the normal operating state of the storage cell 5, no substances or gases can escape from the interior of the storage cell.

If, in an extreme case, e.g. in the event of an extremely severe accident sustained by the vehicle, the high-voltage accumulator or the storage cell 5 is damaged, this can cause the internal short-circuiting of the cell, thereby resulting in an increase in pressure and/or temperature in the interior of the storage cell 5. In the event of an overshoot of a predefined pressure, the emergency degassing opening 6 opens or fails, such that hot, or potentially even burning gas 7 can escape from the interior of the storage cell 5 into the interior space 4 of the high-voltage accumulator.

In a region above the emergency degassing opening 6, in the exemplary embodiment according to FIG. 1, a cell contact-connection system 8 is arranged, by means of which the poles of different storage cells are electrically interconnected, such that a plurality of storage cells can be interconnected to constitute cell modules.

In the exemplary embodiment according to FIG. 1, a granulate layer 9 is provided on the cell contact-connection system 8 or is integrated in the cell contact-connection system 8. The granulate layer 9 can be, for example, a layer or coating of raw perlite, i.e. a volcanic rock in which a number of water entrapments are incorporated.

In the event of the escape of hot or burning gas from the storage cell via the emergency degassing opening 6, this gas enters into contact with the cell contact-connection system 8, and thus with the granulate layer 9. The resulting strong heat-up vaporizes the water contained in the granulate layer 9, and thus produces a substantial swelling of the granulate layer 9, as a result of which a strong fire-inhibiting and insulating action is generated vis-à-vis the wall 2 of the high-voltage accumulator 1. The risk that hot or burning gas escaping from the storage cell 5 will damage or perforate the wall 2 is thus substantially reduced.

FIG. 2 shows a variant of the invention, in which the granulate layer is arranged on an inner side of the wall (the underside of the cover of the high-voltage accumulator) which faces the storage cell 5 or the emergency degassing opening 6.

Where hot or burning gas escaping from the storage cell 5 enters into contact with the granulate layer 9, as described above, this results in a substantial expansion of the granulate layer 9, as a result of which the wall 2 is thermally protected.

Naturally, the two exemplary embodiments according to FIGS. 1 and 2 can also be mutually combined, i.e. the granulate layer 9 can not only be arranged either on the cell contact-connection system or on the wall 2, but also on both the cell contact-connection system 8 and on the wall 2, and/or can be arranged on other components of the high-voltage accumulator which, in an extreme case, can be exposed to hot or burning gas 7 escaping from the storage cell 5.

What is claimed is:

1. A vehicle having:
a high-voltage accumulator (1), which comprises a high-voltage accumulator housing,
at least one storage cell (5) arranged in the high-voltage accumulator housing, incorporating an emergency degassing opening (6) which, in a normal state of the storage cell (5), is closed in a gas-tight manner and which, in the event of an overshoot of a predefined internal pressure in the interior of the storage cell (5), opens such that hot or burning gas (7) can escape from the storage cell (5) into the high-voltage accumulator housing,
characterized in that, in subregions of the high-voltage accumulator (1), which are arranged in the region of the emergency degassing opening (6) of the at least one storage cell (5), granulates (9) are provided which, in the event of heat-up associated with the application of hot or burning gas (7) thereto, undergo expansion.

2. The vehicle according to claim 1, characterized in that the granulates (9) contain a volcanic rock, particularly raw perlite.

3. The vehicle according to claim 1 or 2, characterized in that water is entrapped in the granulates (9) which, in the event of the heat-up of the granulates (9), vaporizes and expands the granulates (9).

4. The vehicle according to one of claims 1 to 3, characterized in that the granulates (9) are arranged on an inner side of a wall (2) of the high-voltage accumulator housing.

5. The vehicle according to one of claims 1 to 4, characterized in that the granulates (9) are arranged on a cell contact-connection system (8) or are integrated in a cell contact-connection system (8), by means of which the poles of a plurality of storage cells (5) are electrically interconnected.
